(19) United States
(12) Patent Application Publication
(10) Pub. No.: US 2007/0089761 A1
(43) Pub. Date: Apr. 26, 2007

(54) Non-plasma method of removing photoresist from a substrate

(76) Inventors: Souvik Banerjee, Fremont, CA (US); Ramesh B. Borade, Livermore, CA (US); Srini Raghavan, Tucson, AZ (US); Peggi Cross, Tucson, AZ (US)

Correspondence Address: Joshua L. Cohen;BOC, Inc., Legal Services-IP Dept., 575 Mountain Ave., Murray Hill, NJ, 07974, US

(21) Appl. No.: 11/255,695

(22) Filed: Oct. 21, 2005

(51) Int. Cl. B08B 7/00; B08B 3/00

(52) U.S. Cl. 134/34; 134/19

(57) ABSTRACT

A method is provided to remove in particular ion implanted photoresist from a substrate, such as a semiconductor wafer, consisting of heating the photoresist for deforming an interface of a crust and bulk layer of the photoresist, and controlling a temperature of the heating for cracking the photoresist.

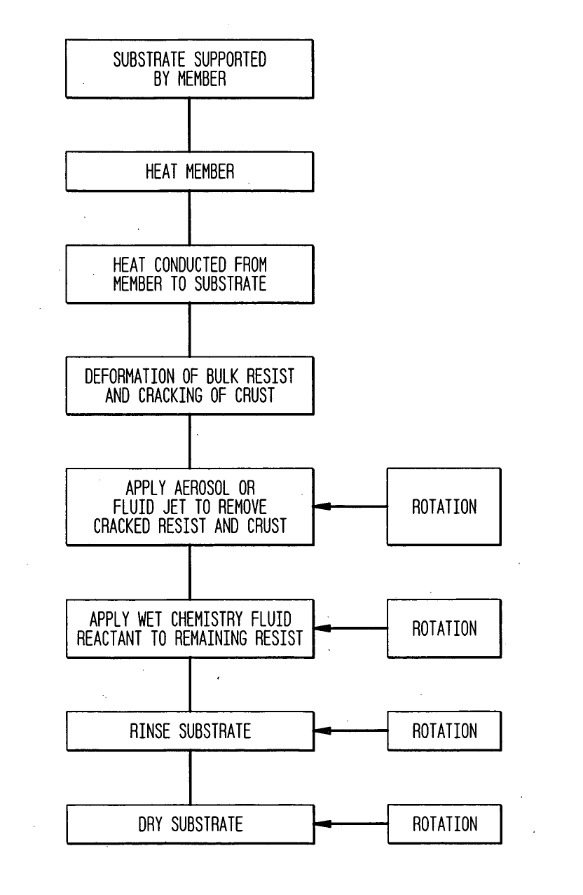

### BACKGROUND OF THE INVENTION

The invention relates to methods for removing photoresist from surfaces of substrates having photoresist thereon for patterning and in particular where the resist is used as a masking layer and is a hard baked resist such as an ion implanted resist.

By way of example, surfaces of substrates, such as semiconductor, metal, dielectric, and other surfaces of semiconductor wafer or integrated circuits, may have photoresist deposited therein during processing. The photoresist acts as a mask in certain steps requiring implantation of ions at energies of 1 kilo electron volt (“keV”) to 100 keV. The ion implantation process causes ion bombardment of the photoresist surface. This results in a dense upper layer or coating known as (scum or crust) beneath which is a bulk layer of the photoresist. This scum or crust layer can often be twenty percent (20%) of the thickness of the resist. Precision removal of such photoresist is required without damaging the substrate or electronic components being fabricated at said substrate surface. Photoresist may also be referred to as “resist”.

Cryogenic cleaning systems and other methods are known to remove various particulate matter and contaminants from surfaces. While such physical systems have been employed to remove particulate contaminants from surfaces, such have not proved capable of safely and effectively removing photoresist from these surfaces.

Boron, arsenic or phosphorous ions are implanted into the silicon substrate to accurately and controllably dope the silicon with impurity atoms during the formation of source, drain and well regions of metal oxide silicon (“MOS”) transistors. The photoresist during the implant step is used as a mask to protect regions of the substrate from being exposed to the ion bombardment. Specifically, in a complimentary metal oxide silicon (“CMOS”) fabrication, when the N doped metal oxide silicon (“NMOS”) transistor source/drain (“S/D”) regions are formed, the patterned photoresist covers the P doped metal oxide silicon (“PMOS”) transistors. The S/D for NMOS is formed by implantation of Arsenic or Phosphorous ions at dosages of greater than 1 E15 atoms per sq.cm. (cm²) and energies of 2-100 keV. During the implant process, the photoresist masking the PMOS transistor area is exposed to the Arsenic or Phosphorous ion bombardment. The ion bombardment of the resist surface results in abstraction of hydrogen atoms from the resist outer layer. This outer layer, about 20% of the total resist thickness, is known as the crust and is rich in carbon-carbon bonds. The crust is highly cross-linked, graphite like structure, which is dense and non-porous and therefore, substantially impervious to known chemical applications to breach the crust to remove same and the underlying bulk resist. In effect, the crust shields the more easily removable bulk resist lying beneath the crust. Removal of the crust and the bulk resist is necessary in order to proceed with further processing of the substrate.

Known methods to remove the crust and bulk resist include a combination of plasma ashing followed by wet cleaning. Plasma ashing consist of two steps. In the first step, radio frequency (“RF”) plasma is used in a low temperature process to remove the carbonized outer layer. In this step, also known as de-scum, the crust is essentially sputtered away by the energetic ions of the plasma. In the second step, the substrate is heated up to 350° Centigrade (“C”) to ash away the bulk resist (also known as bulk strip) on the substrate using oxygen rich plasma chemistry. The byproduct of this bulk ashing step includes carbon dioxide (CO₂) and water (H₂O) vapor, which are removed from the substrate and pumped away. Thereafter, a wet chemistry is employed to remove any remaining resist residue. The wet chemistry is often a mixture of sulfuric acid and hydrogen peroxide (collectively “SPM”) at a 5:1 concentration and at temperatures of 90°-120° C. Device manufacturers may also use an additional wet cleaning step using SC1 chemistry which is a mixture of ammonium hydroxide, hydrogen peroxide and water at about 1:1:5 concentrations and at a temperature of about 70° C. to remove particulate contaminants from the substrate surface following the previous SPM chemistry step.

There are several process concerns and disadvantages associated with plasma ashing to remove photoresist, especially in microelectronics manufacturing:
a) oxidizing plasma oxidizes the polysilicon regions thereby resulting in silicon recess
b) high plasma temperature of up to 350° C. results in diffusion of mobile ions into gate oxide; and
c) in back-end-of-line (“BEOL”) processes, the plasma ashing step causes damage to low dielectric constant materials and subsequent increase in dielectric constant from loss of carbon from the materials.

### SUMMARY OF THE INVENTION

The present invention provides a method of removing photoresist, particularly high dose implanted resist, without using plasma ashing to remove the resist.

The present invention provides for a method of treating a substrate, such as for example a semiconductor wafer, to remove ion implanted photoresist disposed thereon and includes:

A method of weakening hard baked photoresist for removal from a substrate, comprising heating the photoresist for deforming an interface of a crust and bulk layer of the photoresist, thereby cracking the photoresist.

A method of removing photoresist from a substrate, comprising conducting heat from the substrate to crack a crust of the photoresist; providing an aerosol to the photoresist to displace the cracked photoresist from the substrate; and applying a fluid reactant to the photoresist to react therewith.

A method of removing photoresist from a substrate, comprising conducting heat from a substrate to crack a crust of the photoresist; and providing a fluid jet to the photoresist to displace the cracked photoresist and remove photoresist residue from the substrate.

A method of removing photoresist from a substrate, comprising conducting heat to the substrate to crack a crust and bulk resist of the photoresist; providing a fluid aerosol or a fluid jet to the photoresist to displace the cracked photoresist from the substrate; and applying a fluid reactant to the photoresist remaining on the substrate to react therewith.

Heating of the substrate conducts heat to the photoresist to become heated upon which a reaction occurs to the photoresist which causes internal stress to crack the scum layer or crust of the photoresist. The cracking continues from the crust through the underlying bulk resist so that the photoresist is more susceptible to subsequent physical and chemical removal processes. The cracked resist is physically removed after which physical and chemical processes, such as wet cleaning, may be used to completely clean the photoresist and any residue thereof.

These and various other aspects, features and embodiments of the present invention are further described herein. The sequence of steps in the present invention may also be varied.

### BRIEF DESCRIPTION OF THE DRAWINGS

For a more detailed description of the present invention, reference may be had to the accompanying drawing which is briefly described below. The drawing is illustrative and is not necessarily drawn to scale. The drawing illustrates various aspects or features of the present invention and may illustrate one or more embodiment(s) or example(s) of the present invention in whole or in part.

The drawing FIGURE discloses a flow chart for the process of the invention.

### DESCRIPTION OF THE INVENTION

The present invention is directed to a process for treating a substrate to remove photoresist deposited thereon, especially when the photoresist becomes crusted due to a prior ion implantation process. By way of example, the method may be used on a surface of a semiconductor substrate to be fabricated or on an integrated device (hereinafter referred to, for example, as “substrate” or “surface”).

In the description of the invention herein, it will be understood that a word appearing in the singular encompasses its plural counterpart, and a word appearing in the plural encompasses its singular counterpart, unless implicitly or explicitly understood or stated otherwise. It will also be understood that for any given component described herein, any of the possible alternatives listed for that component, may generally be used individually or in combination with one another, unless implicitly or explicitly understood or stated otherwise. It will be further understood that any list of such alternatives is merely illustrative, not limiting, unless implicitly or explicitly understood or stated otherwise.

The method described herein may be used in connection with any substrate requiring photoresist removal. The substrate may be any substrate that has a surface that comprises a semiconductor material, a metal or a dielectric material, merely by way of example. Thus, while a term such as “semiconductor,” “metal,” “dielectric,” may be used in relation to a surface of a substrate, such as a semiconductor substrate or an integrated circuit, it will be understood that the method described herein may be used in connection with any suitable surface of a substrate. While a term such as “semiconductor” or “integrated circuit” may be used in relation to a substrate, it will be understood that the method described herein may be used in connection with any suitable substrate. Merely by way of example, a suitable substrate may be a hard disk medium, an optical medium, a gallium arsenide (“GaAs”) medium, and a suitable surface may be any surface of any such substrate, such as any film or any layer on any such substrate.

It will also be understood that reference to a “photoresist” or “resist” will be used interchangeably herein, and refers to the protective polymer coating applied to a substrate to protect features and components disposed on the substrate.

A surface of the substrate has a photoresist adhered to the substrate surface and is resistant to displacement and removal by a physical force alone such as a cryogenic stream. The method of the present invention is used to effectively remove the photoresist without damaging the substrate or electronics thereon.

By way of example of the process, the substrate is disposed for heating on a support member such as a platen or platform. The heat is provided or conveyed to the substrate by, preferably, conduction, i.e. the platen for example is heated to a desired temperature and the resulting heat of the platen is conducted to the substrate which in turn conducts the heat to the photoresist. The bulk resist has the heat conducted to it from the substrate, the heat being further conducted to the crust of the resist. Any heat source may be used in conjunction with the platen.

Heating of the photoresist can also occur by convection or radiation, although heating of the photoresist by conduction is the preferred means. Heating of the substrate helps enhance photoresist removal capability by cracking the crust and bulk resist of the photoresist.

The platen is heated to the temperature ranging from 120°-350° C., and preferably in the range of from 170°-280° C., and from five seconds up to 5 minutes and preferably up to one minute. The heat may be provided to the substrate by convection, radiation, conduction or a combination thereof, and preferably the heat is conducted from the platen to the substrate to result in the substrate being heated to a temperature of 170° to 280° C., at from 15 seconds to one minute. During the heating step, the platen preferably remains stationary with the substrate thereon. The heating takes place preferably in an atmospheric pressure chamber purged with nitrogen gas to avoid any oxidation of the silicon surface. The heat is preferably conducted directly from the platen to the substrate, to the bulk resist and then to the overlying crust of the resist.

The crust of the photoresist and the bulk underlying portion of the photoresist each have different elastic properties. That is, the crust has essentially little if no elasticity, while the bulk resist having been protected by the crust during ion bombardment is relatively elastic. Application of the heat to the substrate causes the bulk resist to begin to dry out and deform, thereby wrinkling, while the overlying crust remains firm and accordingly cannot deform or wrinkle due to its substantially non-elastic properties. This results in stress generated, in particular at an interface of the crust and bulk layer of the photoresist, thereby cracking the photoresist. The deformation in the crust layer causes at least one and most notably a plurality of cracks to occur in the crust layer, which cracks extend substantially down through the bulk resist to the underlying substrate as the heat is provided. Cracking typically occurs initially at the crust, although is not limited to the crust.

The cracks or fissures which result in the crust and bulk resist will continue until the heat ceases or upon total removal of the elastic qualities of the bulk resist. At this stage, with the hardened scum layer cracked and the cracks continuing down into the bulk resist, the photoresist structural integrity is compromised, thereby enabling additional steps to remove the crust and the bulk resist from the substrate. The resist cracking process preferably occurs at atmospheric pressure.

Thereafter, physical removal of the cracked or fractured crust and bulk resist can be effected by use of an aerosol or fluid jet. The aerosol or fluid jet step will remove the crust and some of the bulk resist. The aerosol essentially consists of solid particles entrained in a gas. The solid particles are preferably cryogenic particles such as Argon, Nitrogen, Carbon dioxide, or combinations thereof. Alternatively, the aerosol is liquid droplets entrained in a gas such as nitrogen; or clean dry air (“CDA”) can also be employed during the aerosol removal step. The fluid jet comprises a stream of liquid or gas directed at the substrate. This step occurs for from one second up to five minutes. Movement, such as rotation, of the platen and hence the substrate may occur during this step.

An alternate embodiment of the invention calls for the heating and the aerosol or fluid jet application steps to occur simultaneously. For example, the substrate is heated and during the heating step a cryogen aerosol is applied as well to the photoresist. The different temperatures, sometimes selectively substantial, of such application also facilitate cracking and removal of the resist. Controlling the temperature of the heat applied to the photoresist facilitates cracking in a plurality of ways. In particular, the temperature selected for the heat can be maintained or increased to crack the resist. The temperature of the heat can be reduced to shock the photoresist and thereby effect cracking of same. The reduction in temperature can be accomplished by bathing the substrate having the heated resist thereon in a cryogen bath or subjecting the resist to a cryogen spray for example.

A wet chemistry fluid reactant can be used to remove any remaining bulk resist or crust from the substrate. At this stage of the process, only the bulk resist usually remains as the aerosol or fluid jet step has effectively removed the fractured crust. A sulfuric acid and hydrogen peroxide (“SPM”) mixture may be used during this fluid reactant step. The temperature of the substrate during this step can be from 30° to 190° C. Megasonics may be used to further remove particles of resist and other contaminants and the substrate can be rotated at speeds of up to 1000 revolutions per minute (“rpm”). The substrate can then be rinsed with deionized (“DI”) water after which the substrate can be dried by spinning or application of isopropyl alcohol (“IPA”) to the substrate. The drying step occurs from one minute up to twenty minutes and may involve substrate rotation at up to 1000 rpm. Other gases such as clean dry air or N₂ may also be applied during this stage of the process to dry the substrate.

The chemical or chemicals for the fluid reactant may include by way of example aminoethoxy ethanol, hydroxylamine, catechol, N methylpyrrolidone, tetramethyl ammonium hydroxide, propylene carbonate, tetra butyl alcohol, hydrogen peroxide, sulfuric acid, ammonium hydroxide, isopropyl alcohol, pantothenyl alcohol (also known as Vitamin B5), mixture of: sulfuric acid and hydrogen peroxide (SPM), mixture of: ammonium hydroxide, hydrogen peroxide and water (“SC1”), or combinations thereof.

In the process, the aerosol spray or liquid droplets are sufficient to physically act on the photoresist to be removed from the surface of the substrate. The aerosol spray or fluid jet may be a cryogenic agent or fluid, such as a cryogenic gas comprising carbon dioxide, argon, nitrogen, or any suitable combination thereof, by way of example. The spray may also be liquid droplets entrained in gas.

As mentioned above, the process may employ multiple cleaning media, one of which comprises a reactive agent or fluid that has a high vapor pressure, as further described below. The reactive fluid is capable of reacting with the photoresist that is targeted for removal from the substrate. The reactive fluid is supplied to the photoresist in an aerosol, spray, stream or jet in a cleaning process according to the present invention. The substrate may be stationary or rotating during the application of the reactive fluid. The substrate surface may also be at elevated temperatures of 300 to 190° C. to enhance the chemical reaction between the photoresist remaining on the substrate surface and the reacting fluid.

The reactive agent or fluid may be a reactive liquid, as described above, a reactive gas or vapor, as is now described, or any combination of the two. Hereinafter, merely by way of simplicity or brevity, a reference to reactive gas may encompass a reactive vapor, and a reference to a reactive vapor may encompass a reactive gas, unless otherwise indicated or understood. The reactive fluid may comprise a reactive gas, a reactive vapor, a reactive vapor of a reactive liquid, or any combination thereof, that is capable of reacting chemically with a material that is targeted for removal from a surface of a substrate.

As described previously, this reactive fluid is supplied to the surface of the substrate, such as in an aerosol, a spray, a stream or a jet, according to the present invention.

### EXAMPLES

### Example 1

A thin layer of hexamethyldisilane (“HMDS”) followed by Shipley 248 nm DUV photoresist was spun on bare silicon wafer. The thickness of the resist layer was 1 μm. The resist was then hard baked and implanted with Arsenic ions 1E16 atoms/sq.cm. at 80 keV. The first step of the non-plasma resist removal process comprised of heating the wafer at 180° C. for 60 seconds. The heating cracked the crust of and the bulk resist. The sample was then subjected to a cryogenic aerosol stream which removed the cracked upper crust along with some of the bulk resist. Subsequent treatment at 80° C. by dispensing low volumes of chemicals directly onto the residue for 60 seconds followed by DI water rinse and drying removed the resist completely. The chemicals used were organic solvents such as n-methylpyrrolidone (“NMP”) and dimethyl sulfoxide (“DMSO”).

### Example 2

The wafer sample prepared as in Example 1 above was subjected to heating at 180° C. for 60 seconds to crack the resist. The wafer was then taken and subjected to CO₂ cryogenic aerosol stream to remove the cracked resist crust along with some of the bulk resist. The process time in the aerosol stream was one minute. The wafer with the remaining resist was then subjected to spin spray of 5:1 sulphuric-hydrogen peroxide mixture (SPM) at a temperature of 110° C. for one minute. This enabled the remaining resist to be completely removed. The wafer was then dried using spin rinse drying to provide a clean silicon surface.

Thus, according to the present invention, the aerosol and wet chemistry steps are employed either separately or in combination to remove resist material from a surface of a substrate after heating. The cryogenic cleaning step and the reactant cleaning step may be carried out simultaneously, sequentially or in any combination thereof.

The present invention is advantageous in that it facilitates the effective removal of photoresist from a substrate surface, particularly ion-implanted photoresist, without the need to use plasma ashing.

It will be understood that the embodiments described herein are merely exemplary, and that a person skilled in the art may make many modifications and variations of same without departing from the spirit and scope of the invention. All such modifications and variations are intended to be included within the scope of the invention as defined in the claims herein.

1. A method of weakening hard baked photoresist on a substrate for removal from the substrate, comprising: heating the photoresist for transmitting heat to an interface of a crust and a bulk layer of the photoresist, and for drying the photoresist; controlling a temperature of the heating; and deforming the bulk layer and the interface with the heat for stressing the interface to crack the photoresist.

2. The method according to claim 1, wherein the controlling comprises maintaining the temperature of the heating of the photoresist.

3. The method according to claim 1, wherein the controlling comprises increasing the temperature of the heating of the photoresist.

4. The method according to claim 1, wherein the controlling comprises reducing the temperature of the heating of the photoresist.

5. The method according to claim 4, wherein the reducing the temperature comprises cooling the photoresist.

6. The method according to claim 5, wherein the cooling comprises subjecting the photoresist to a cryogenic substance.

7. The method according to claim 1, wherein the heating comprises conducting heat to the photoresist.

8. The method according to claim 7, wherein the conducting heat is from the substrate.

9. The method according to claim 1, further comprising; removing cracked photoresist from the substrate.

10. The method according to claim 9, wherein the heating and the removing occur simultaneously.

11. The method according to claim 9, wherein the removing comprises applying a fluid jet to the cracked photoresist to remove the cracked photoresist from the substrate.

12. The method according to claim 9, wherein the removing comprises applying a fluid aerosol to the cracked photoresist to remove the cracked photoresist from the substrate.

13. The method according to claim 12, wherein the fluid aerosol comprises solid cryogenic particles entrained in gas.

14. The method according to claim 13, wherein the solid cryogenic particles are selected from the group consisting of argon, nitrogen, carbon dioxide, and combinations thereof.

15. The method according to claim 12, wherein the fluid aerosol comprises liquid droplets entrained In a gas.

16. The method according to claim 15, wherein the gas is selected from the group consisting of nitrogen, clean dry air, and combinations thereof.

17. The method according to claim 12, wherein the fluid aerosol is applied for from five seconds up to five minutes.

18. The method according to claim 11, further comprising moving the substrate during application of the fluid jet.

19. The method according to claim 12, further comprising moving the substrate during application of the fluid aerosol.

20. The method according to claim 18, wherein the moving comprises rotational movement of the substrate.

21. The method according to claim 19, wherein the moving comprises rotational movement of the substrate.

22. The method according to claim 1, further comprising applying a fluid reactant to the cracked photoresist to react with the photoresist.

23. The method according to claim 22, wherein the fluid reactant is selected from the group consisting of aminoethoxy ethanol, hydoxylamine, catechol, N methylpyrrolidone, tetramethyl ammonium hydroxide, propylene carbonate, tetra butyl alcohol, hydrogen peroxide, sulfuric acid, pantothenyl alcohol, ammonium hydroxide, isopropyl alcohol, mixture of sulfuric acid and hydrogen peroxide, mixture of ammonium hydroxide, hydrogen peroxide and water, and combinations thereof.

24. The method according to claim 9, further comprising rinsing the substrate.

25. The method according to claim 24, wherein the rinsing is with one selected from the group consisting of deionized water, organic solvents, and combinations thereof.

26. The method according to claim 24, further comprising drying the substrate.

27. The method according to claim 26, wherein the drying is with isopropyl alcohol.

28. The method according to claim 26, wherein the drying further comprises heating the substrate, passing a gas over the substrate, and rotating the substrate.

29. The method according to claim 28, wherein the gas comprises nitrogen.

30. The method according to claim 9, wherein the removing of the cracked photoresist is at a temperature not greater than the temperature to crack the photoresist.

31. The method according to claim 1, wherein the temperature is between 120″-350° C.

32. The method according to claim 1, wherein the hard baked photoresist is ion implanted photoresist.

33. The method according to claim 22, further comprising rotating the substrate during the applying of the fluid reactant.

34. The method according to claim 22, wherein the fluid reactant is provided to the photoresist for from 15 seconds to 5 minutes.

35. The method according to claim 1, wherein the heating of the photoresist is in a nitrogen environment.

36. The method according to claim 1, wherein the cracking occurs initially at the crust.

37. A method of removing photoresist from a substrate, comprising: conducting heat from the substrate for drying a bulk layer of the photoresist and stressing an interface between the bulk layer and a crust of the photoresist for cracking the photoresist; providing an aerosol to the photoresist to displace the cracked photoresist from the substrate; and applying a fluid reactant to the photoresist to react therewith.

38. The method according to claim 37, further comprising supporting the substrate on a support member and providing heat to the support member to conduct heat to the substrate.

39. A method of removing photoresist from a substrate, comprising: conducting heat from the substrate for drying a bulk layer of the photoresist and stressing an interface between the bulk layer and a crust of the photoresist for cracking the photoresist; and providing a fluid jet to the photoresist to displace the cracked photoresist and remove photoresist residue from the substrate.

40. The method according to claim 39, further comprising supporting the substrate on a support member and providing heat to the support member to conduct heat to the substrate.
